(19) United States
(12) Patent Application Publication
(10) Pub. No.: US 2007/0175086 A1
(43) Pub. Date: Aug. 2, 2007

(54) Apparatus for protecting against insect attacks

(76) Inventor: Raleigh William Baird III, Houston, TX (US)

Correspondence Address: CONLEY ROSE, P.C.;David A. Rose, P. O. BOX 3267, HOUSTON, TX, 77253-3267, US

(21) Appl. No.: 11/346,035

(22) Filed: Feb. 2, 2006

(51) Int. Cl. A01M 7/00

(52) U.S. Cl. 43/132.1; 43/900

(57) ABSTRACT

Apparatus and method for protecting against and stopping an attack by stinging flying insects. The apparatus is portable and activated by the victim. A tank contains a surfactant, and the tank is fluidly connected by a hose with a delivery system that is characterized by a plurality of spray nozzles. In response to an attack by stinging flying insects, an operator activates an electric pump that delivers the surfactant from the tank to the delivery system under pressure via the hose. The surfactant is expelled from the delivery system as a spray or mist, and envelopes the operator under attack by stinging flying insects, contacting the operator and insects and resulting in the death of the insects and the stopping of the attack. The tank, pump, hose and delivery system are incorporated into a self-contained, portable, and movable platform.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention relates generally to protecting against stinging flying insects, and more particularly relates to a sprayer apparatus for thwarting stinging flying insect attacks. Still more particularly, the present invention relates to an apparatus for delivering a spray or mist of surfactant to stop an attack of stinging bees and to assist victims in evading such attacks.

### BACKGROUND

Despite their value as pollinators and producers of honey and wax, bees are generally unwelcome in the vicinity of people because of the possibility that the bees may swarm, attack, and repeatedly sting those nearby. Bees may attack unsuspecting persons without provocation, and leave the person without a defense to the swarm. Increasing the concerns associated with bee attacks is the migration of “Africanized” honeybees into the southern regions of the United States. These Africanized honeybees attack with more intensity and persistence than the indigenous species of honeybee, often stinging their victim hundreds of times. With the movement of Africanized honeybees, or so-called “killer bees,” into an area, it becomes even more important to make available means to protect against and end attacks by swarming bees before the results are fatal.

Research has shown that a person may defend against attacks from certain bees by exposing the bees to a surfactant spray or mist. In some instances, the surfactant may comprise a mixture of soap and water. The soap, upon contacting a bee, breaks down the waxy protective covering of the bee's breathing system, thereby drowning the bees in the water. Sprayer devices that deliver a low volume flow of a surfactant spray or mist in response to an attack are effective for controlling and killing certain less aggressive, indigenous bees. However, a low volume surfactant spray or mist response may not be suitable to combat an attack by a swarm of more aggressive “killer bees” given the greater intensity and persistence of attack.

A surfactant spray or mist method of bee protection may be effective and practicable in situations where a capable sprayer device is readily available and can be quickly moved into proximity to apply the surfactant spray or mist to the person under attack. Even then, however, a person under attack by stinging bees may become incapacitated and unable set up and operate the equipment alone, and thus must to wait for help to arrive. The victim is typically forced to wait until the fire department or another responder with the capability to rescue a victim from a stinging fling insect attack can arrive. To further compound the problem, attacks by aggressive bees often occurs in remote locations where prompt response from the fire department or other responder is unlikely or even impossible, thereby making the chance of a high volume sprayer device arriving in time to end the attack unreliable. Ranchers and farmers, for example, are frequently alone when attacked, such as when operating a tractor, entering a remote barn or shed, cutting brush, or fixing fences. As such, a need exists for a portable system that can provide a spray or mist of surfactant with enough intensity to effectively protect against and stop a large swarm of aggressive killer bees, and that can be arranged to be self-administered with little thought or coordinated effort when under the stress of an attack.

### SUMMARY OF THE PREFERRED EMBODIMENTS

The embodiments of the present invention are directed to apparatus for delivering a spray or mist of an insect-killing solution, such as a surfactant, to a person being stung by bees. It is desired to provide a flying insect protection device that is portable, self-contained, and can deliver a flow of surfactant spray or mist sufficient to quickly kill and/or thwart a large swarm of aggressive bees. The embodiments of the flying insect protection device described herein allow for use of the flying insect protection device in various environments and applications that can be utilized when rapid outside rescue response is not reliably available.

In one embodiment of the present invention, the flying insect protection device includes a tank, an electric pump, a hose, a delivery system, and a surfactant. The tank may be comprised of plastic or fiberglass and may be sized according to the desired level of portability for each embodiment of the device. The electric pump is desired to have enough power to deliver the surfactant at a flow rate of 1-3 gallons per minute (GPM) and may be integral to the tank. The hose is a tubular line capable of fluid communication that is connected between the tank and the delivery system. The delivery system is characterized by a plurality of spray nozzles through which the surfactant is expelled. The surfactant is contained in the tank, and may be comprised of soap and water. In certain embodiments, the delivery system includes a halo-shaped header that is supported above the head of the person to be protected. An alternative embodiment includes disposing the delivery system on the ground with the spray nozzles directed upward. In such embodiments, the spray nozzles are disposed about the halo so as to create a column-like protective spray.

The flying insect protection device is preferably portable, self-contained, and capable of being conveyed in a variety of manners. In certain embodiments, the tank is worn by the person to be protected, and includes shoulder straps, similar to a backpack. Alternatively, the tank may be mounted on a wheeled hand-truck or dolly to assist in moving the flying insect protection device to the desired location. In another embodiment, the tank is mounted on a wheeled wagon. Further, the flying insect protection device may be integrated into a wheeled rescue vehicle, such as an ambulance or fire truck. In the embodiments where the tank is mounted as a backpack, on a hand-truck, dolly or wagon, or integral to a wheeled rescue vehicle, a battery and battery charger are included as components of the flying insect protection device to power the electric pump and to maintain the battery's power, respectively. An additional alternative embodiment includes mounting the flying insect protection device to a lawn tractor or farm tractor.

When a person in proximity of a flying insect protection device is attacked by a swarm of bees, the person may take the delivery system in hand and activate the electric pump to pressurize the surfactant. The surfactant is pumped from the tank by the electric pump through the hose and to the delivery system. The surfactant is atomized when pumped through the plurality of spray nozzles of the delivery system, creating a surfactant spray or mist that is directed to soak the person under attack. The surfactant spray or mist also contacts the bees attacking the victim, killing the stinging bees and stopping the attack.

Thus, the present invention comprises a combination of features and characteristics that are directed to overcoming various shortcomings of prior devices. The various characteristics described above, as well as other features, will be readily apparent to those skilled in the art upon reading the following detailed description of the preferred embodiments of the invention, and be referring to the accompanying drawings.

### BRIEF DESCRIPTION OF THE DRAWINGS

For a more detailed description of the embodiments, reference will now be made to the following accompanying drawings, wherein:

FIG. 1A is a schematic elevation view of the halo embodiment of the flying insect protection device disposed on a farm tractor;

FIG. 1B is a schematic elevation view of the nozzle embodiment of the flying insect protection device disposed on a farm tractor;

FIG. 2A is a top view of the halo embodiment of the delivery system;

FIG. 2B is a partial cross-sectional view of the halo embodiment shown in FIG. 2A;

FIG. 3A is a cross-section view of a sprayer embodiment of the delivery system;

FIG. 3B is a front view of the sprayer embodiment of the delivery system shown in FIG. 3A;

FIG. 3C is a cross-sectional view of a straight-line sprayer embodiment of the delivery system;

FIG. 4 is a cross-sectional view of a tank used in one embodiment of the delivery system;

FIG. 5 is a schematic elevation view of a flying insect protection device disposed on a wagon;

FIG. 6 is a schematic elevation view of a flying insect protection device disposed on a hand-truck or dolly;

FIG. 7 is an elevation view of one embodiment of the delivery system in use.

### DETAILED DESCRIPTION OF THE EMBODIMENTS

In the drawings and description that follows, like parts are marked throughout the specification and drawings with the same reference numerals, respectively. The drawing figures are not necessarily to scale. Certain features of the invention may be shown exaggerated in scale or in somewhat schematic form, and some details of conventional elements may not be shown in the interest of clarity and conciseness.

The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. Further, use of any form of the terms “connect”, “engage”, “couple”, “attach”, or any other term describing an interaction between elements is not meant to limit the interaction to direct interaction between the elements and may also include indirect interaction between the elements described. The various characteristics mentioned above, as well as other features and characteristics described in more detail below, will be readily apparent to those skilled in the art upon reading the following detailed description of the embodiments, and by referring to the accompanying drawings.

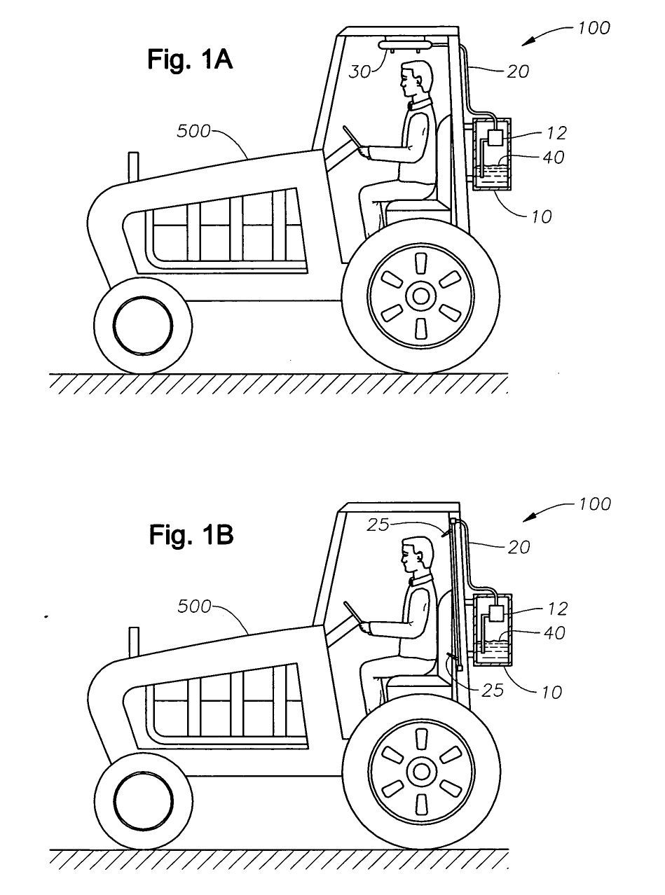

Referring initially to FIG. 1A, flying insect protection device 100 is shown. Flying insect protection device 100 includes tank 10, electric pump 12, hose 20, delivery system 30, and surfactant 40. Electric pump 12 is preferably a self-priming, diaphragm pump that is positioned integrally to tank 10, and is preferably powered by a DC motor (not shown). Hose 20 is connected between tank 10 and delivery system 30. In certain embodiments, hose 20 is a tubular line, and may be comprised of rubber, plastic, or other suitable flexible tubular material. Hose 20 may likewise be comprised of rigid or non-rigid conduit. Tank 10 is filled with surfactant 40 and may have a volumetric capacity in the range of four to twenty gallons. In this particular embodiment, tank 40 preferably has a volumetric capacity of 16 gallons. In certain embodiments, tank 10 is comprised of plastic, fiberglass, or any other suitable light-weight material. In the present embodiment, tank 10 and delivery system 30 of flying insect protection device 100 are mounted to a wheeled vehicle, such as tractor 500, with the delivery system 30 preferably positioned in an area above the operator of tractor 500. The DC motor driving electric pump 12 is preferably powered by connection to the battery (not shown) of tractor 500.

Referring now to FIG. 1B, an alternative embodiment of flying insect protection device 100 is shown. In this embodiment, device 100 includes tank 10, electric pump 12, hose 20, spray jets 25, and surfactant 40. Spray jets 25 are mounted to tractor 500 in proximity to the operator and are fluidly connected to tank 10 via hose 20. Surfactant 40 is delivered from tank 10 via hose 20 to spray jets 25 under pressure from electric pump 12, and is expelled from spray jets 25 in the direction of the operator. In one embodiment, spray jets 25 may be mounted above the operator and to the left and the right of the operator, thereby surrounding the operator on at least three sides. Spray jets 25 may be comprised of brass, and may deliver a wide-field spray of surfactant 40, a more concentrated direct stream of surfactant 40, or some combination thereof.

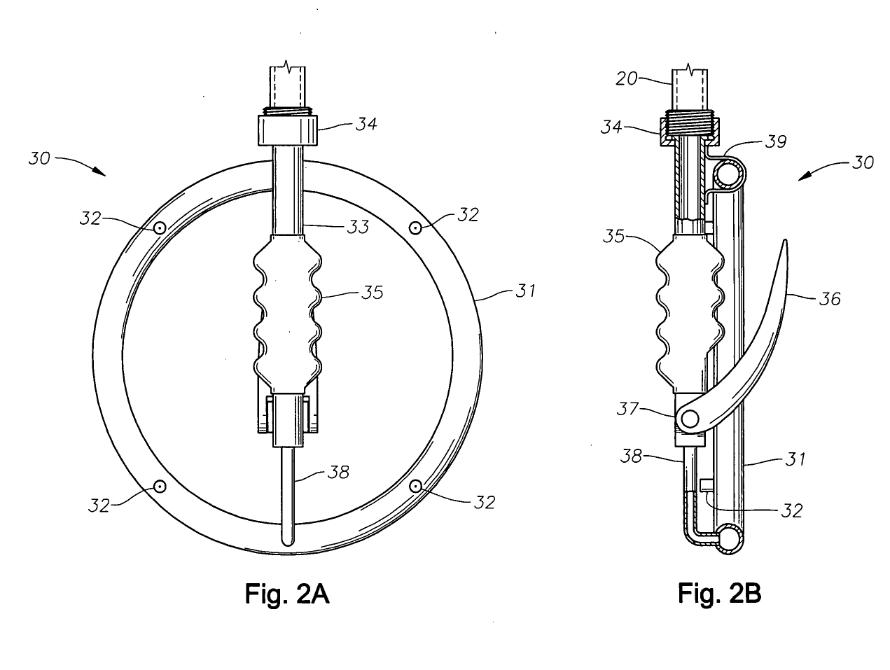

Referring now to FIGS. 2A and 2B, an embodiment of delivery system 30 is shown. In this embodiment, delivery system 30 is characterized by header 31 and a plurality of spray nozzles 32. Header 31 is a tubular member, formed in a halo-like shape, which may be comprised of ½-inch diameter stainless steel piping. In certain embodiments, header 31 forms a circular halo that is approximately 12 to 24 inches in diameter. Spray nozzles 32 are mounted on the outer surface of header 31, spaced equally on header 31, and in fluid communication with the interior diameter of header 31. Nozzles 32 may be comprised of brass, and may deliver a wide-field spray of surfactant 40, a more concentrated direct stream of surfactant 40, or some combination thereof. Header 31 need not be circular, but in other embodiments, may be arcuate or linear.

Delivery system 30 is also characterized by supply tubing 33, hose couple 34, grip 35, trigger 36, valve 37, and feed tubing 38. Supply tubing 33 is a tubular member capable of fluid communication, and is connected between hose couple 34 and grip 35. Supply tubing 33 is oriented radially to header 31, and may be secured to header 31 by clamp 39. Supply tubing 33 connects with grip 35 at one end, creating a passage for fluid flow into grip 35 when hose 20 is attached to hose couple 34. Grip 35 is capable of fluid communication, and incorporates trigger 36, which is used to open and/or close valve 37 located in the fluid path when trigger 36 is depressed. Feed tubing 38 is oriented radially with respect to header 31, and is connected between grip 35 and header 31 at the opposite end of grip 35 from supply tubing 33. Feed tubing 38 is a tubular member capable of fluid communication, and creates a passage for fluid flow such that feed tubing 38, grip 35 and header 31 are in fluid communication.

When an operator in proximity to flying insect protection device 100 is attacked by stinging flying insects, device 100 is utilized to deliver a spray or mist of surfactant 40 from delivery system 30 that envelopes the person under attack. The operator may take delivery system 30 in hand by grasping grip 35, actuating trigger 36 to open valve 37 and to close a switch (not shown), thereby activating electric pump 12. In the embodiment shown in FIG. 1, the operator does not need to grasp grip 35 of delivery system 30. Electric pump 12 pressurizes surfactant 40 contained in tank 10, delivering surfactant 40 through hose 20 to delivery system 30 under pressure. Upon reaching delivery system 30, surfactant 40 enters header 31 and flows to nozzles 32. The pressure on surfactant 40 created by electric pump 12 forces surfactant 40 through nozzles 32, thereby delivering surfactant 40 in a stream, spray, mist or small droplets. As the column of spray or mist of surfactant 40 is applied to and envelopes the operator under attack, the spray or mist of surfactant 40 also contacts the attacking bees in the vicinity. The attacking bees exposed to the spray or mist of surfactant 40 from delivery system 30 are stopped and killed.

It is preferred that electric pump 12 deliver the spray or mist of surfactant 40 through spray nozzles 32 at a flow rate of 1-3 gallons per minute. In the embodiment of delivery system 30 shown in FIGS. 2A and 2B, the spray or mist of surfactant 40 provided by delivery system 30 has a maximum linear range of 6 to 8 feet, and provides a coverage area based on a spray zone of 6 feet in diameter. In certain embodiments, surfactant 40 is a soap-water mixture, wherein the ratio of soap to water is 1:10. Alternatively, surfactant 40 may also be comprised of a 1:10 mixture of detergent and water, or a 1:10 mixture of shampoo and water, as further examples.

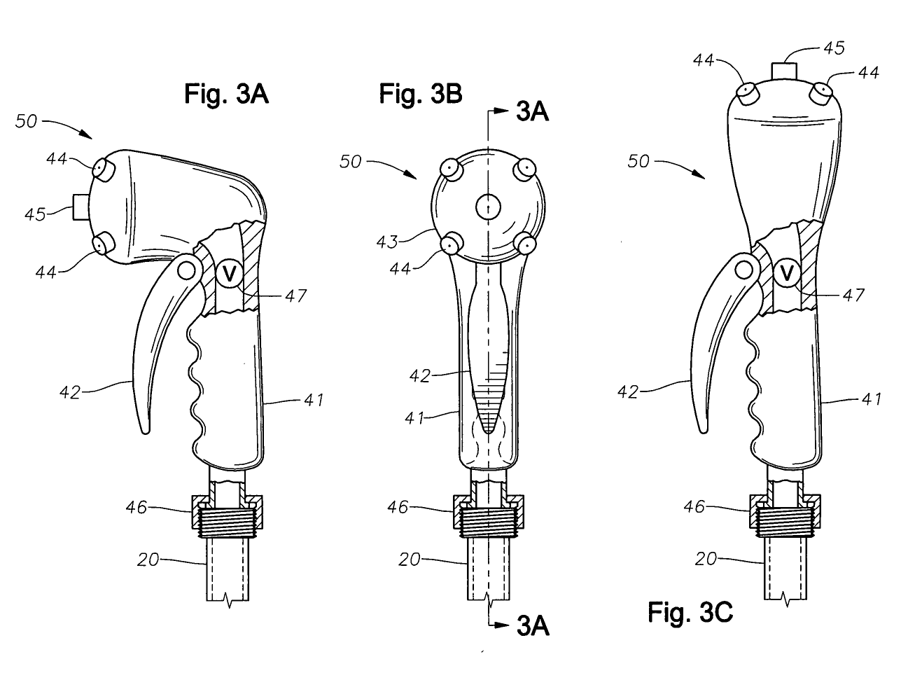

Referring to FIGS. 3A, 3B, and 3C, device 100 may alternatively use an embodiment of delivery system 50 shown therein. In this embodiment, delivery system 50 includes a grip 41, trigger 42, nozzle head 43, nozzles 44 and 45, valve 47, and hose couple 46. Delivery system 50 may be generally “L-shaped” and in the style of a garden-watering sprayer, with nozzle head 43 and nozzles 44 and 45 disposed at one end and hose couple 46 disposed at a second end. Delivery system 50 may alternatively be a straight-line sprayer with nozzles 44 and 45 disposed at one end and house couple 46 disposed at a second end. Grip 41 is of the garden-sprayer type, with an internal passage for fluid flow. Hose couple 46 is connected at one end of grip 41 and provides an entry port for surfactant 40 to enter delivery system 50. Hose 20 attaches to hose couple 46, thereby fluidly connecting grip 41 and tank 10. Trigger 42 is disposed on grip 41, and trigger 42 is activated to open and close valve 47 located in the internal passage of grip 41 to control fluid flow.

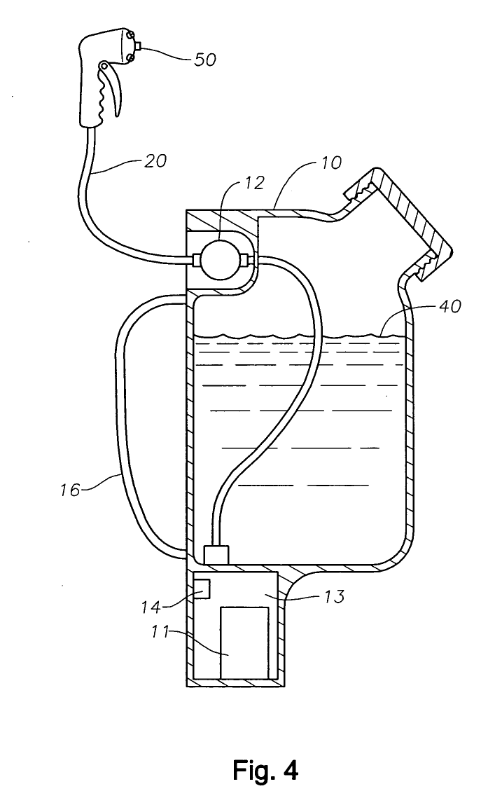

Valve 47 is opened by actuating trigger 42. Depressing trigger 42 further activates a switch (not shown) that energizes electric pump 12, which pressurizes surfactant 40 in tank 10. Surfactant 40 is delivered under pressure via hose 20 to delivery system 50, and flows through grip 41 to nozzles 44 and 45. Surfactant 40 is expelled through nozzles 44 as a spray and nozzle 45 as a stream, and is directed to the operator under attack by stinging bees. Surfactant 40 encompasses the operator and contacts the stinging bees, thereby stopping the attack and killing the bees. This embodiment of delivery system 50 is preferably used with the tank 10 embodiments shown in FIGS. 4 and 6.

The size of tank 10 in the varying embodiments of flying insect protection device 100 is dependent upon the anticipated and/or desired use. Referring now to FIG. 4, in certain embodiments tank 10 is configured such that it can be carried in a manner akin to a backpack, with shoulder straps 16 attached to tank 10 for permitting an operator to support and transport the tank on his or her shoulders and back. With tank 10 suspended from the operator's back, hose 20 connects to delivery system 50. Hose 20 may have a length in the range of 3-6 feet. Tank 10 is filled with surfactant 40, and preferably has a volumetric capacity of 4 gallons in this embodiment. Additionally, in this embodiment, a battery 11 is mounted in battery housing 13 of tank 10 in order to provide power for electric pump 12. A battery charger 14 is also included in this embodiment of flying insect protection device 100 as part of tank 10 in order to keep battery 11 charged with sufficient power to run electric pump 12.

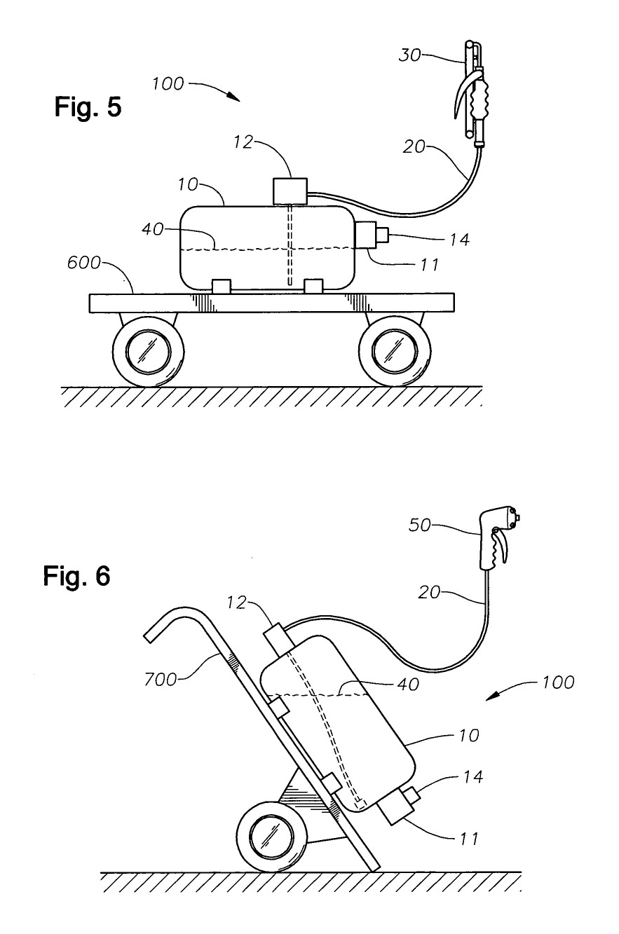

Referring now to FIG. 5, in an alternative embodiment flying insect sprayer device 100 is shown with tank 10 mounted on a portable platform such as wagon 600. Tank 10 is filled with surfactant 40, and in this embodiment preferably has a volumetric capacity of 8 gallons. In this embodiment, an operator may take delivery system 30 in hand and direct the spray or mist of surfactant 40 onto him or herself. Alternatively, delivery system 50 may be used in this embodiment to deliver surfactant 40.

Referring to FIG. 6, in an additional alternative embodiment of flying insect protection device 100 is shown with tank 10 mounted on a hand-truck 700. Tank 10 is filled with surfactant 40, and in this embodiment preferably has a volumetric capacity of 8 gallons. In this embodiment, an operator may take delivery system 50 in hand and direct the spray or mist of surfactant 40 onto him or herself. Alternatively, delivery system 30 may be used in this embodiment to deliver surfactant 40. Additionally, in the embodiments related to FIGS. 5 and 6, battery 11 is positioned integrally to tank 10 in order to provide power for electric pump 12. A battery charger 14 is also included in these embodiments of flying insect protection device 100 in a manner integral to tank 10 in order to keep battery 11 charged with sufficient power to run electric pump 12.

All of the above-described embodiments mounted to a portable platform allow the flying insect protection device 100 to be portable and easily accessible to an operator within a short time of a bee attack. Further, these embodiments allow an operator to engage the device by a simple pull of a trigger or the pressing of a switch. More importantly, the embodiments discussed herein allow a victim to operate the device without the need of outside intervention and independent of rescue efforts, despite the stress of the attack.

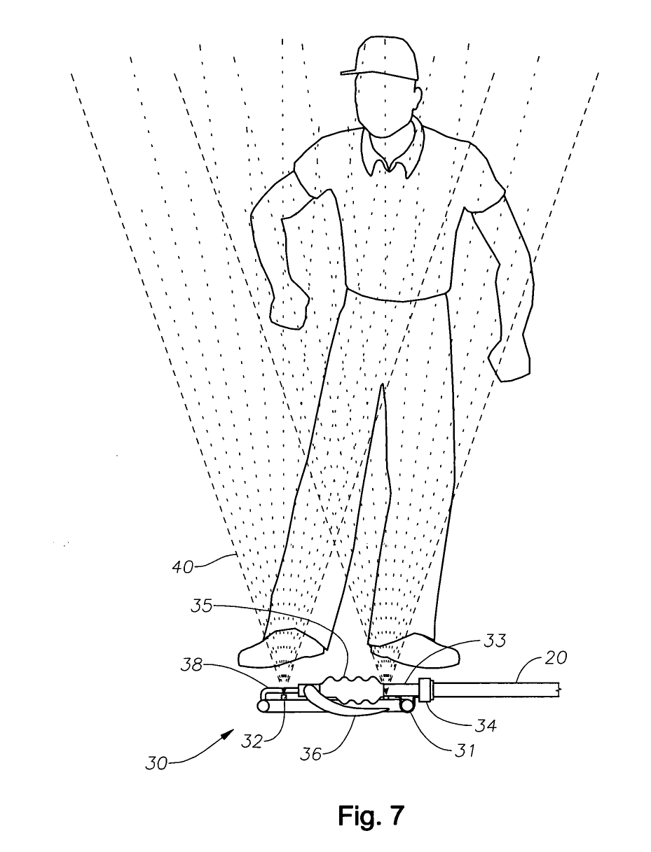

Referring to FIG. 7, in an alternative embodiment delivery system 30 is shown positioned on the ground, allow an operator under attack from a swarm of bees to position him or herself within the mist of surfactant 40 expelled from delivery system 30. In this embodiment, delivery system 30 is oriented such that spray nozzles 32 are directed upward. The upwardly directed spray nozzles 32 send a spray or mist of surfactant 40 up from the ground to create an insect defeating barrier of surfactant 40 that envelopes the operator. In this embodiment, the operator activates delivery system 30 by actuating and locking trigger 36 in the activated position, and then placing delivery system 30 on the ground so that nozzles 32 are directed upward.

While preferred embodiments of this invention have been shown and described, modifications thereof can be made by one skilled in the art without departing from the scope or teaching of this invention. The embodiments described herein are exemplary only and are not limiting. It will be appreciated that many other modifications and improvements to the disclosure herein may be made without departing from the scope of the invention or the inventive concepts herein disclosed. Because many varying and different embodiments may be made within the scope of the present inventive concept, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

1. An assembly for stopping an attack of flying stinging insects on a user, the assembly comprising:
a tank containing a surfactant;
a pump in fluid communication with the tank;
a delivery system having at least one nozzle;
a tubular member fluidly connecting the tank and the delivery system;
wherein the tank, the pump, the delivery system, and the tubular member are incorporated into a portable platform; and
an actuator, operable by the user, for activating the pump to pressurize the surfactant in order to expel the surfactant from said delivery system onto the user.

2. The assembly of claim 1 wherein said pump delivers said surfactant at a flow rate in the range of one gallon per minute to three gallons per minute.

3. The assembly of claim 1 wherein said surfactant is expelled a distance of at least six feet from said delivery system.

4. The assembly of claim 1 wherein said surfactant is comprised of soap and water mixed at a ratio of 1:10.

5. The assembly of claim 1 wherein said delivery system comprises a tubular member having a generally circular shape.

6. The assembly of claim 1 wherein said delivery system comprises a hand-held trigger sprayer.

7. The assembly of claim 1 wherein said tank is mounted to said user as a backpack.

8. The assembly of claim 1 wherein the portable platform is a pull-wagon.

9. The assembly of claim 1 wherein the portable platform is a hand-truck.

10. The assembly of claim 1 wherein the portable platform is a wheeled rescue vehicle.

11. The assembly of claim 1 wherein said delivery system comprises a plurality of nozzles.

12. A portable assembly for stopping an attack by stinging flying insects on an operator, the assembly comprising:
a tank containing a surfactant and mounted to a portable platform;
a delivery system having at least one nozzle and positioned in proximity to the operator;
a tubular member fluidly connecting the tank and the delivery system;
an electric pump adapted to convey said surfactant from the tank to the delivery system; and
an actuator, operable by the operator, for causing the pump to deliver the surfactant to the delivery system under pressure, thereby causing the surfactant to be expelled from said nozzle.

13. The assembly of claim 12 wherein said delivery system comprises a plurality of nozzles.

14. The assembly of claim 13 wherein the delivery system is a tubular member formed in a halo-like shape.

15. The assembly of claim 12 wherein the delivery system is mounted above the operator.

16. The assembly of claim 13 wherein the plurality of nozzles is mounted to said portable platform and are oriented to spray said operator from at least three different directions.

17. The assembly of claim 12 wherein the portable platform is a tractor.

18. The assembly of claim 12 wherein said pump expels said surfactant at a flow rate of one gallon per minute to three gallons per minute.

19. The assembly of claim 12 wherein said surfactant is expelled a distance of at least six feet from said delivery system.

20. The assembly of claim 12 wherein the surfactant is comprised of soap and water mixed at a ratio of 1:10.

21. The assembly of claim 13 wherein said delivery system is supported above the head of the user and further wherein said plurality of nozzles are oriented to spray in the direction of the operator.

22. The assembly of claim 15 wherein said plurality of nozzles are oriented to spray in the direction of the operator.

23. A portable pumping assembly comprising:
a portable platform;
a tank mounted on said portable platform;
a solution comprising an insect-killing agent contained in said tank;
a fluid delivery system comprising at least one nozzle for dispensing fluid therethrough;
a conduit disposed between said tank and said fluid delivery system, said tank and fluid delivery system being in fluid communication with one another;
an electric pump mounted on said portable platform and adapted to pump said solution from said tank to said delivery system and out of said nozzle;
a manual actuator adapted to activate said pump to cause the solution on said tank to be pumped through said conduit to said fluid delivery system and out of said nozzle.

24. The apparatus of claim 23, wherein said fluid delivery system fixer comprises a tubular header in fluid communication with said conduit, said header comprising a plurality of nozzles.

25. The apparatus of claim 24, wherein said header is curved.
